(19) United States
(12) Patent Application Publication
(10) Pub. No.: US 2006/0261112 A1
(43) Pub. Date: Nov. 23, 2006

(54) ATV mounting bracket and associated methods

(76) Inventors: George D. Gates, West Jordan, UT (US); Travis D. Gates, Riverton, UT (US)

Correspondence Address: THORPE NORTH & WESTERN, LLP., 8180 SOUTH 700 EAST, SUITE 200, SANDY, UT, 84070, US

(21) Appl. No.: 11/329,398

(22) Filed: Jan. 9, 2006

Related U.S. Application Data
(63) Continuation-in-part of application No. 29/228,175, filed on Apr. 20, 2005, now Pat. No. D515910.

(51) Int. Cl. B60R 7/00; B60R 9/00; B60R 11/00

(52) U.S. Cl. 224/558; 224/401

(57) ABSTRACT

A mounting bracket for use in mounting at least one auxiliary device to an ATV includes a body and an engaging section, associated with the body. The engaging section is configured to engage a portion of the ATV to limit movement of the body relative to the ATV in at least one degree of freedom. Connecting means are associated with the body for connecting the body to the portion of the ATV. An auxiliary device receiving area is coupled to the body and is operable to receive and secure an auxiliary device to the bracket. The receiving area is formed of a material having a hardness relatively greater than a hardness of the body.

This application is a continuation-in-part of copending U.S. patent application Ser. No. 29/228,175, filed Apr. 20, 2005, which is hereby incorporated herein in its entirety.

### FIELD OF THE INVENTION

The present invention relates generally to systems for mounting auxiliary devices to vehicles. More particularly, the present invention relates to systems for mounting auxiliary devices to all-terrain-vehicles (“ATVs”) that are subject to considerable vibrational forces during use.

### BACKGROUND OF THE INVENTION

All-terrain-vehicles (“ATVs”) are used by many people for recreation, hunting, transportation, outdoors work activities, etc. As part of many of these activities, the person participating in the activity desires to carry with them an auxiliary device such as a rifle, shotgun, tools, bow, scopes, camera equipment, etc. In order to safely and effectively operate the ATV while transporting such equipment, the operator often mounts the auxiliary devices to the ATV to maintain the hands of the operator in a free condition. In an effort to ensure that such auxiliary devices are safely and securely attached to the ATV while it is being operated, a variety of mounting systems have been developed that are generally both securely attached to the ATV and also provide secure attachment of the auxiliary device to the mounting system.

In general, such mounting systems are developed to ensure that the interface between the auxiliary device to be mounted and the ATV is sufficiently secure that the auxiliary device does not become dislodged from the ATV while the ATV is operated. As ATVs are often operated in rugged terrain, the mounting system generally incorporates a relatively robust design to ensure that the auxiliary device is securely held, and that the mounting system is not bent or otherwise damaged due to the weight of the auxiliary device. In addition, the mechanism that secures the auxiliary device to the mounting system must remain secured even when carrying the auxiliary device is subject to the often considerable vibrational forces induced by movement of the ATV over rough terrain.

Due to the forces such mounting devices are subjected to, conventional mounting devices have primarily been formed of metallic materials that often add significant weight to the overall weight of the ATV, are often costly to machine, and often present a less-than desirable aesthetic appearance. Thus, while it may have been desired to form such mounting devices from a lightweight, inexpensive and easily manufactured material, the forces imparted to the mounting system by the auxiliary device while the mounting system is in use have discouraged such design attempts. In particular, it has been found that the coupling interface between the mounting bracket and the auxiliary device, which is often a threaded coupling, is subjected to forces of a magnitude sufficient to “strip” or otherwise damage threads formed in any but the most robust of materials.

Accordingly, while it has been attempted to provide a more lightweight, easily manufactured and aesthetically pleasing mounting system for use in mounting auxiliary devices to ATVs, the conventional solutions require either very bulky and heavy systems or systems that risk inadvertent dislodging of the auxiliary devices from the ATV.

### SUMMARY OF THE INVENTION

The present invention provides a mounting bracket for use in mounting at least one auxiliary device to an ATV, including a body and an engaging section associated with the body. The engaging section can be configured to engage a portion of the ATV to limit movement of the body relative to the ATV in at least one degree of freedom. Connecting means can be associated with the body for connecting the body to the portion of the ATV. An auxiliary device receiving area can be coupled to the body and can be operable to receive and secure an auxiliary device to the bracket. The receiving area can be formed from a material having a hardness relatively greater than a hardness of the body.

In accordance with another aspect of the invention, a mounting bracket for use in mounting at least one auxiliary device to an ATV is provided, including a body and an engaging section associated with the body. The engaging section can be configured to engage a portion of the ATV to limit movement of the body relative to the ATV in at least one degree of freedom. Connecting means can be associated with the body for connecting the body to the portion of the ATV. An auxiliary device receiving area can be coupled to the body and can be operable to receive and secure an auxiliary device to the bracket. The body can include at least two support sections supporting the auxiliary device receiving area. The at least two support sections can each taper downwardly and outwardly from the auxiliary device receiving area to an outer periphery of the body.

In accordance with another aspect of the invention, a method for forming a mounting bracket for use in mounting at least one auxiliary device to an ATV is provided, including the steps of: obtaining a body having an engaging section associated therewith, the engaging section being configured to engage a portion of the ATV to limit movement of the body relative to the ATV in at least one degree of freedom; and coupling an insert at least partially within the body, the insert including: i) an auxiliary device receiving area operable to receive and secure an auxiliary device to the bracket; and ii) a lower portion having interference structure associated therewith, the interference structure operable to engage the body to limit movement of the insert relative to the body in at least two degrees of freedom.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1A is a perspective view of a mounting bracket for use in mounting an auxiliary device to an ATV in accordance with an embodiment of the present invention;

FIG. 1B is a bottom view of the mounting bracket of FIG. 1A;

FIG. 1C is a top view of the mounting bracket of FIG. 1A;

FIG. 1D is a side view of the mounting bracket of FIG. 1A, taken along a front side of the bracket shown in FIG. 1C;

FIG. 2 is a side view of a mounting bracket in accordance with an embodiment of the invention, shown coupled to a portion of an ATV and having a portion of an auxiliary device coupled thereto;

FIG. 3A is a top view of a mounting bracket insert in accordance with an embodiment of the invention;

FIG. 3B is a side view of the insert of FIG. 3A; and

FIG. 3C is a bottom view of the insert of FIG. 3A.

### DETAILED DESCRIPTION

Before the present invention is disclosed and described, it is to be understood that this invention is not limited to the particular structures, process steps, or materials disclosed herein, but is extended to equivalents thereof as would be recognized by those of ordinarily skilled in the relevant arts. It should also be understood that terminology employed herein is used for the purpose of describing particular embodiments only and is not intended to be limiting.

It must be noted that, as used in this specification and the appended claims, the singular forms “a” and “the” include plural referents, unless the context clearly dictates otherwise. Thus, for example, reference to a “lifting link” includes one or more of such links and reference to “parallel link” includes reference to one or more of such links.

Definitions

In describing and claiming the present invention, the following terminology will be used in accordance with the definitions set forth below.

As used herein, the term “auxiliary device” is to be understood to refer to an object that can be mounted to at least a portion of an ATV in order to be transported by the ATV. Examples of auxiliary devices include, without limitation, tools, such as shovels, rakes, picks, etc., guns, bows, camera equipment, scopes, and also intermediate structures on which such devices can be mounted or rested.

Distances, forces, weights, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 inch to about 5 inches” should be interpreted to include not only the explicitly recited values of about 1 inch to about 5 inches, but also include individual values and sub-ranges within the indicated range. Thus, included in this numerical range are individual values such as 2, 3, and 4 and sub-ranges such as from 1-3, from 2-4, and from 3-5, etc.

This same principle applies to ranges reciting only one numerical value and should apply regardless of the breadth of the range or the characteristics being described.

Invention

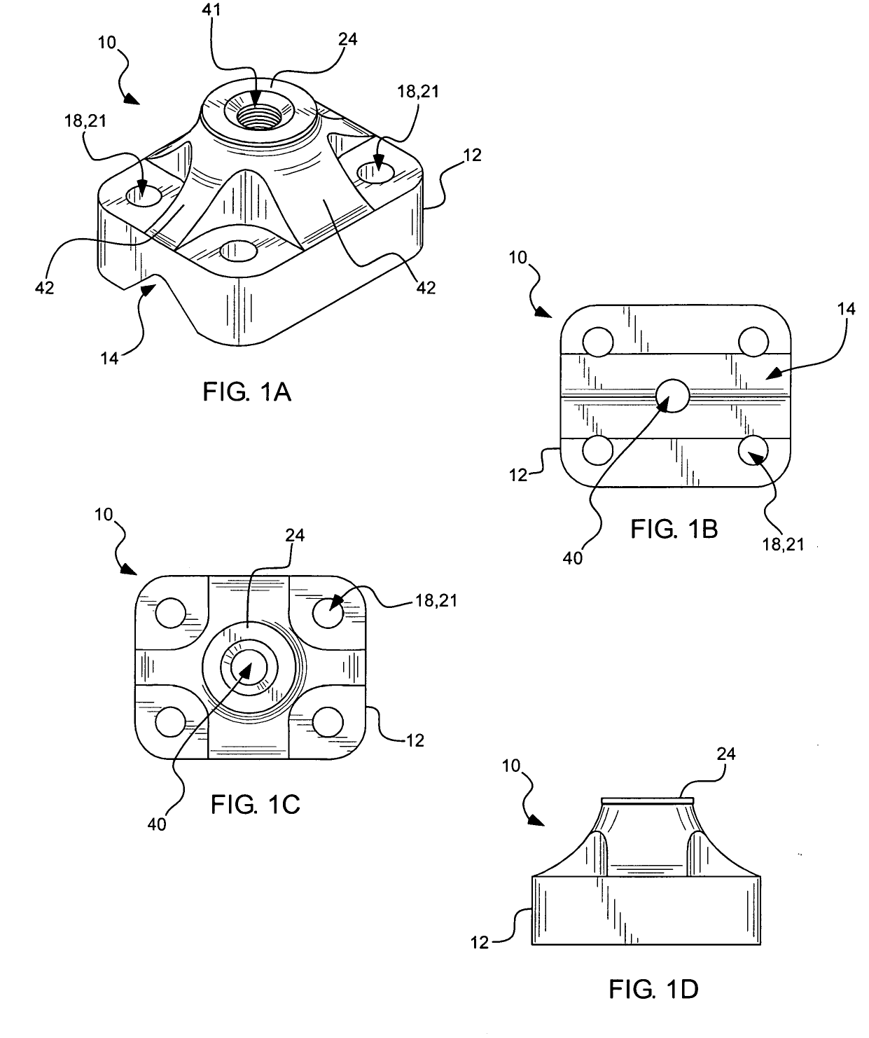

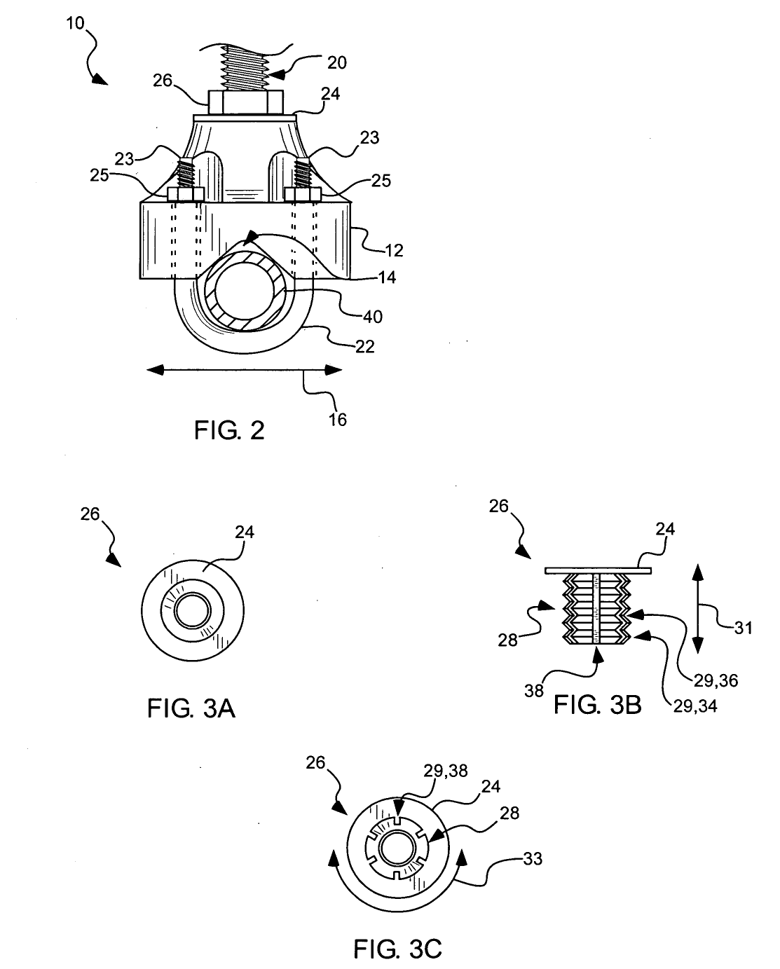

A system, indicated generally at 10 in FIGS. 1A through 2, in accordance with the present invention is shown for a mounting bracket for use in mounting at least one auxiliary device (20 in FIG. 2) to an ATV (a portion of which is shown at 40 in FIG. 2). The mounting bracket can include a body 12 that can include an engaging section 14 associated therewith. The engaging section can be configured to engage a portion (40 in FIG. 2, which can be, for example, a handlebar or similar feature) of the ATV to limit movement of the body relative to the ATV in at least one degree of freedom. In the embodiment illustrated in the figures, the engaging section includes a generally elongate triangular section into which the portion 40 of the ATV can be engaged. As shown in FIG. 2, the body 12 can thereby be restricted from moving relative to the portion of the ATV in at least the degree of freedom represented by directional indicator 16.

While the engaging section 14 is shown as a generally elongate triangular section in the embodiments illustrated in the figures, it is to be understood that the present invention is not so limited, as the engaging section can include a variety of shapes and configurations suitable for engaging a portion of an ATV; including a square or rectangular shape, oval or circular shape, etc. In addition, the engaging section can include a recessed portion such as that shown, or it can include structure (not shown) that extends from the body to engage the portion of the ATV.

The mounting bracket 10 can also include connecting means, shown by example at 18, associated with the body 12, for connecting the body to the portion of the ATV. In the example shown in the figures, the connecting means includes a series of holes 21 through which a connector can be secured to mount the bracket to the portion of the ATV. For example, connector 22 (FIG. 2) can be a generally U-shaped bolt with two threaded ends 23 onto which nuts 25 can be engaged to secure the U-shaped bolt about the portion 40 of the ATV to secure the bracket to the ATV. While a U-shaped bolt is shown in FIG. 2. it is to be understood that one or more straight bolts can also be used as the connector, as well as a variety of similar structures.

The connecting means 18 can include a variety of suitable structure, including structure capable of receiving a fastener, such as a bolt or screw, therethrough, as well as structure capable of attaching to another device, such as a clamp, a strap assembly, etc. Also, while four holes 21 arranged about the body 12 are shown in the figures, it is to be understood that the connecting means can be oriented in a variety of locations about the body and can include a variety of numbers of holes or similar structure.

An auxiliary device receiving area 24 can be coupled to or otherwise associated with the body 12. The receiving area can be operable to receive and secure an auxiliary device (e.g., nut 26 of auxiliary device 20 in FIG. 2) to the bracket 10. While not so required, the receiving area 24 can be formed of a material different than a material of which the body is formed. In the example shown, the receiving area is formed of a material having a hardness that is relatively greater than a hardness of the body. In this manner, the body can be formed from a material selected for beneficial properties of the body as a whole, such as weight, manufacturability, cost, etc., without requiring that the body material be suitable for mating with a portion (e.g., a threaded nut) of the auxiliary device.

The auxiliary device receiving area 24 can form a portion of an insert 26 (shown in most detail in FIGS. 3A, 3B and 3C) that can be disposed at least partially within the body 12, as shown in the embodiments of FIGS. 1A through 2. The insert can include a lower portion 28 having interference structure (shown generally at 29) associated therewith. The interference structure can be operable to engage the body 12 to limit movement of the insert 26 relative to the body 12 in at least two degrees of freedom (shown by exemplary linear axis of translation 31 and exemplary direction of rotation 33). Thus, in the embodiment illustrated in FIGS. 3A, 3B and 3C, the interference structure limits movement of the insert relative to the body in two degrees of freedom, e.g., direction 31 that represents potential translational movement of the insert into and out of the body 12, and direction 33 that represents potential rotational movement of the insert within the body 12.

The interference structure 29 can take a variety of forms. In one aspect of the invention, the interference structure includes a series of peaks 34 and valleys 36 arranged in a generally horizontal orientation (relative to the insert as it is held within the body in the orientation shown in FIG. 2). While not so required, at least some of the series of peaks can be interrupted by one or more vertical slots 38. In this embodiment, the peaks and valleys can aid in limiting movement of the insert relative to the body in direction 31, while the slots 38 can aid in limiting movement of the insert relative to the body in direction 33. In addition to the peaks and valleys shown, the interference structure can include threaded structure, diamond knurled structure, etc.

As will be appreciated, the interference structure 29 will be most effective when engaged by a relatively large percentage of internal portions of the body 12. To facilitate a good interface between the insert 26 and the body, the body can be formed around the interference structure of the insert during manufacture of the mounting bracket. For example, in those embodiments of the invention in which the body is formed from a polymer material, the body can be molded or cast about the insert while the polymer is in an uncured state. As the polymer cures, it will harden in and among the peaks, valleys and slots to securely embed the insert within the body.

Thus, in one embodiment of the invention, the body 12 can be formed from a type of material that can be injected, molded or otherwise encompass the insert during manufacture of the mounting bracket. The body can be formed of a polymer, nylon, plastic, etc. In one aspect, the body is formed of Nylon 6. The insert, and thus, in some embodiments, the auxiliary device receiving area 24 can be of a material selected for its ability to securely mate with attachment structure 26 of the auxiliary device 20. In one aspect of the invention, the insert can be formed from a metal, such as brass, steel, stainless steel, aluminum, etc.

By forming the insert 26 and the body 12 from different materials, the present invention allows selection of the various sections or portions of the mounting bracket based on the optimal qualities of each of those sections or portions. For example, the body material can be selected so as to be lightweight, easily formed, easily machined, etc., while the insert can be selected to more readily engage the auxiliary device and connecting structure associated therewith, e.g., to readily and securely mate with a nut or bolt portion of the auxiliary device. In the embodiment shown, the nut 26 of the auxiliary device 20 can be tightened with a great deal of force against the receiving area of the insert 26 to ensure that the auxiliary device remains secured to the mounting bracket, even in the presence of significant vibrational forces induced by movement of the ATV.

The mounting bracket 10 can also include an open channel 40 (FIGS. 1B and 1C) that can be formed through the auxiliary device receiving area 24 and through the body 12. The open channel can be configured to allow a connector to pass through the body without contacting internal portions of the body. In this manner, a connector, such as the threaded portion of the auxiliary device 20 of FIG. 2, can pass completely through the mounting bracket, if desired, without “bottoming out” within the insert or the body. Due to the generally superior strength of the threads (41 in FIG. 1A) of the insert relative to the body, “bottoming out” of a threaded connector within the body can result in the body becoming fractured or otherwise damaged during insertion of the auxiliary device within the insert. The open channel allows the auxiliary device to be inserted and adjusted to a variety of heights relative to the body without risking damage to the body.

The mounting bracket 10 can also include at least two support sections (42 in FIG. 1A) that can support the auxiliary device receiving area 24. The at least two support sections can each taper downwardly and outwardly from the auxiliary device receiving area (relative to the receiving area when it is oriented upwardly with respect to the body) to an outer periphery of the body 12. While not so required, the support sections can include an arcuately sloped taper that gradually but consistently tapers from the receiving area and outwardly and downwardly toward the periphery of the body 12.

The support sections 42 can add strength to the receiving area 24 (where much of the force induced by the auxiliary device will be concentrated), without consuming excess space in and around the receiving area. In this manner, the mounting bracket can be provided with superior holding strength with minimal structure adjacent the interface area where the auxiliary device is mounted and secured to the mounting bracket. The support sections 42 can be formed as a portion of the body 12, as shown in the figures, and can also be coupled to or added upon the body to support the receiving area.

In addition to the structural features discussed above, the present invention also provides a method for forming a mounting bracket for use in mounting at least one auxiliary device to an ATV, including the steps of: obtaining a body having an engaging section associated therewith, the engaging section being configured to engage a portion of the ATV to limit movement of the body relative to the ATV in at least one degree of freedom; and coupling an insert at least partially within the body, the insert including: i) an auxiliary device receiving area operable to receive and secure an auxiliary device to the bracket; and ii) a lower portion having interference structure associated therewith, the interference structure operable to engage the body to limit movement of the insert relative to the body in at least two degrees of freedom.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

We claim:

1. A mounting bracket for use in mounting a device to an ATV, comprising:
a body;
an engaging section, associated with the body, configured to engage a portion of the ATV to limit movement of the body relative to the ATV in at least one degree of freedom;
connecting means, associated with the body, for connecting the body to the portion of the ATV; and
an auxiliary device receiving area, coupled to the body and operable to receive and secure an auxiliary device to the bracket;
the receiving area being formed of a material having a hardness relatively greater than a hardness of the body.

2. The mounting bracket of claim 1, wherein the body is formed of a polymer and the auxiliary device receiving area is formed of a metal.

3. The mounting bracket of claim 3, wherein the body is formed of nylon and wherein the auxiliary device receiving area is formed of brass.

4. The mounting bracket of claim 1, wherein the auxiliary device receiving area forms a portion of an insert disposed at least partially within the body.

5. The mounting bracket of claim 4, wherein the insert includes a lower portion having interference structure associated therewith, the interference structure operable to engage the body to limit movement of the insert relative to the body in at least two degrees of freedom.

6. The mounting bracket of claim 5, wherein the interference structure includes a series of peaks and valleys arranged in a substantially horizontal orientation.

7. The mounting bracket of claim 6, wherein at least some of the series of peaks are interrupted by at least one substantially vertical slot.

8. The mounting bracket of claim 1, further comprising an open channel, formed through the auxiliary device receiving area and the body, the open channel being configured to allow a connector to pass through the body without contacting internal portions of the body.

9. A mounting bracket for use in mounting an auxiliary device to an ATV, comprising:
a body;
an engaging section, associated with the body, configured to engage a portion of the ATV to limit movement of the body relative to the ATV in at least one degree of freedom;
connecting means, associated with the body, for connecting the body to the portion of the ATV;
an auxiliary device receiving area, coupled to the body and operable to receive and secure an auxiliary device to the bracket;
the body including at least two support sections supporting the auxiliary device receiving area, the at least two support sections each tapering downwardly and outwardly from the auxiliary device receiving area to an outer periphery of the body.

10. The mounting bracket of claim 9, wherein the support sections include an arcuately sloped taper.

11. The mounting bracket of claim 9, wherein the auxiliary device receiving area is formed from a material having a hardness relatively greater than a hardness of the body.

12. The mounting bracket of claim 9, wherein the auxiliary device receiving area is formed from an insert disposed at least partially within the body.

13. The mounting bracket of claim 12, wherein the insert includes a lower portion having interference structure associated therewith, the interference structure operable to engage the body to limit movement of the insert relative to the body in at least two degrees of freedom.

14. The mounting bracket of claim 13, wherein the interference structure includes a series of peaks and valleys arranged in a substantially horizontal orientation.

15. The mounting bracket of claim 14, wherein at least some of the series of peaks are interrupted by a substantially vertical slot.

16. A method for forming a mounting bracket for use in mounting at least one auxiliary device to an ATV, comprising the steps of:
obtaining a body configured to engage a portion of the ATV; and
coupling an insert at least partially within the body, the insert including:
i) an auxiliary device receiving area operable to receive and secure an auxiliary device to the bracket; and
ii) a lower portion having interference structure associated therewith, the interference structure operable to engage the body to limit movement of the insert relative to the body in at least two degrees of freedom.

17. The method of claim 16, wherein the body includes at least two support sections supporting the auxiliary device receiving area, the at least two support sections each tapering downwardly and outwardly from the auxiliary device receiving area to an outer portion of the body.

18. The method of claim 16, wherein the auxiliary device receiving area is formed from a material having a hardness relatively greater than a hardness of the body.

19. The method of claim 16, wherein the interference structure includes a series of peaks and valleys arranged in a substantially horizontal orientation.

20. The method of claim 19, wherein at least some of the series of peaks are interrupted by a substantially vertical slot.

21. A mounting bracket for use in mounting a device to an ATV, comprising:
a body;
connecting means, associated with the body, for connecting the body to the portion of the ATV; and
an insert, disposed at least partially within the body, the insert including an auxiliary device receiving area operable to receive and secure an auxiliary device to the bracket;
the insert being formed of a material having a hardness relatively greater than a hardness of the body.

22. The mounting bracket of claim 21, wherein the insert includes a lower portion having interference structure associated therewith, the interference structure operable to engage the body to limit movement of the insert relative to the body in at least two degrees of freedom.

23. The mounting bracket of claim 22, wherein the interference structure includes a series of peaks and valleys arranged in a substantially horizontal orientation.

24. The mounting bracket of claim 23, wherein at least some of the series of peaks are at least partially interrupted by a substantially vertical slot.
